(19) United States
(12) Patent Application Publication
(10) Pub. No.: US 2026/0342687 A1
(43) Pub. Date: Oct. 29, 2026

(54) METHOD AND APPARATUS OF NODE TRAINING FOR DISTRIBUTED SYSTEM AND DISTRIBUTED SYSTEM

(71) Applicant: SUZHOU METABRAIN INTELLIGENT TECHNOLOGY CO., LTD., Suzhou, Jiangsu (CN)

(72) Inventors: Wei HUANG, Suzhou, Jiangsu (CN); Kefeng ZHU, Suzhou, Jiangsu (CN); Bingbing LI, Suzhou, Jiangsu (CN); Yujie DAI, Suzhou, Jiangsu (CN); Yanwei WANG, Suzhou, Jiangsu (CN); Rengang LI, Suzhou, Jiangsu (CN)

(21) Appl. No.: 19/116,999

(22) PCT Filed: Aug. 2, 2024
(86) PCT No.: PCT/CN2024/109630

§ 371 Date: Mar. 28, 2025

(30) Foreign Application Priority Data
Oct. 16, 2023 (CN) 202311336475.3

(51) Int. Cl. H04L 41/34

(52) U.S. Cl. CPC H04L 41/34

(57) ABSTRACT

A method and apparatus of node training for a distributed system and a distributed system. The method includes: receiving a first data packet sent by a first controlling node; by using the first data packet and a target data packet, executing a target training task of the target controlling node, to obtain a second data packet; and sending the second data packet to a second controlling node, till the target controlling node has received training data of all of the controlling nodes of the distributed system, wherein the second controlling node refers to a next one controlling node of the target controlling node in the logical ring, and the training data of all of the controlling nodes of the distributed system and the target data packet are dispatched to the other nodes than the target controlling node in the target node set.

### CROSS-REFERENCE TO RELATED APPLICATION

The present application claims the priority of the Chinese patent application filed on Oct. 16th, 2023 before the Chinese Patent Office with the application number of 202311336475.3 and the title of “METHOD AND APPARATUS OF NODE TRAINING FOR DISTRIBUTED SYSTEM AND DISTRIBUTED SYSTEM”, which is incorporated herein in its entirety by reference.

### FIELD

The embodiments of the present application relate to the field of computers, and particularly relate to a method and apparatus of node training for a distributed system and a distributed system.

### BACKGROUND

As the processing capacity of a single node cannot satisfy the continuously growing tasks of calculation and storage, the emergence of distributed systems solves the problem of the insufficient processing capacity of a single node. In order to enable all of the nodes of the distributed system to normally operate, usually it is required to perform node training to the distributed system. In the related art, each of the nodes is allocated the training data, and subsequently the node executes the training task to the training data to realize the training. However, such a processing mode requires repeatedly allocating the training data to each of the nodes before the node can execute the training task, which results in resource waste. Furthermore, with the increasing of the quantity of the nodes, the efficiency of the node training of the distributed system decreases accordingly.

The problems such as the low efficiency of the node training of the distributed systems in the related art have not haven an effective solution yet.

### SUMMARY

The embodiments of the present application provide a method and apparatus of node training for a distributed system and a distributed system, to at least solve the problem of a low efficiency of the node training of the distributed systems in the related art.

According to an embodiment of the present application, there is provided a method of node training for a distributed system, wherein the method is applied in a target controlling node deployed in the distributed system, nodes comprised by the distributed system are grouped into node sets of a quantity M, wherein M is greater than 1, a plurality of nodes that are comprised by each of the node sets are sequentially connected to obtain a logical chain having a direction, the node sets of the quantity M are sequentially connected to obtain a logical ring having a direction, a last one node of each of the logical chains is a controlling node, the target controlling node refers to each of the controlling nodes, and the method comprises:
receiving a first data packet sent by a first controlling node, wherein the first controlling node refers to a preceding one controlling node of the target controlling node in the logical ring;
by using the first data packet and a target data packet, executing a target training task of the target controlling node, to obtain a second data packet, wherein the target data packet carries training data of all of the nodes in a target node set where the target controlling node is located; and
sending the second data packet to a second controlling node, till the target controlling node has received training data of all of the controlling nodes of the distributed system, wherein the second controlling node refers to a next one controlling node of the target controlling node in the logical ring, and the training data of all of the controlling nodes of the distributed system and the target data packet are dispatched to the other nodes than the target controlling node in the target node set.

In an illustrative embodiment, before the step of, by using the first data packet and the target data packet, executing the target training task of the target controlling node, the method further comprises:
receiving a reference data packet sent by a preceding one node of the target controlling node in the target node set, wherein the reference data packet refers to a data packet that is formed by transmitting and operating training datum of each of the nodes in the target node set sequentially in a target logical chain of the target node set and is formed in the preceding one node; and
by using the reference data packet and a target training datum of the target controlling node, executing the target training task, to obtain the target data packet.

In an illustrative embodiment, before the step of receiving the first data packet sent by the first controlling node, the method further comprises:
detecting operation states of all of the nodes in the target node set; and
in response to a node the operation state of which is an abnormal operation state existing in the target node set, sending first indicating information to a third controlling node in the distributed system, wherein the first indicating information is for indicating that the target node set is in the abnormal operation state, and the third controlling node refers to a controlling node other than the target controlling node in the distributed system.

In an illustrative embodiment, in response to a node the operation state of which is an abnormal operation state existing in the target node set, the method further comprises:
disconnecting a link with the second controlling node.

In an illustrative embodiment, the step of receiving the first data packet sent by the first controlling node comprises:
after the operation states of all of the nodes in the target node set have been detected, in response to all of the operation states of the nodes in the target node set being a normal operation state, receiving the first data packet sent by the first controlling node.

In an illustrative embodiment, the step of detecting the operation states of all of the nodes in the target node set comprises:
detecting response times of all of the nodes in the target node set; and
determining a node in the target node set the response time of which is greater than or equal to a time threshold to be the node the operation state of which is the abnormal operation state.

In an illustrative embodiment, before the step of sending the second data packet to the second controlling node, the method further comprises:
receiving second indicating information sent by a fourth controlling node in the distributed system, wherein the second indicating information is for indicating that the node set where the fourth controlling node is located is in an abnormal operation state; and
in response to the fourth controlling node comprising the second controlling node, building a link with a first instance of the nodes of the logical chain that has a lowest distance to the target controlling node in the logical ring and is in a normal operation state, to obtain a logical ring that has been updated, wherein the logical chains of the quantity M are sequentially connected to obtain the logical ring having the direction.

In an illustrative embodiment, the step of sending the second data packet to the second controlling node comprises:
after the logical ring that has been updated has been obtained, sending the second data packet to a next one controlling node of the target controlling node in the logical ring that has been updated.

In an illustrative embodiment, in response to the fourth controlling node comprising the second controlling node, the step of building the link with the first instance of the nodes of the logical chain that has the lowest distance to the target controlling node in the logical ring and is in the normal operation state comprises:
searching for the second controlling node in the fourth controlling node;
in response to the second controlling node being found, searching for a next one controlling node of the second controlling node in the fourth controlling node; and
in response to the next one controlling node of the second controlling node being not found, building a link with a first instance of the nodes of the logical chain where the next one controlling node of the second controlling node is located, to obtain the logical ring that has been updated.

In an illustrative embodiment, after the step of searching for the next one controlling node of the second controlling node in the fourth controlling node, the method further comprises:
in response to the next one controlling node of the second controlling node being found, continuing to search for the controlling nodes along the logical ring downstream, till a candidate controlling node in the normal operation state is found; and
in response to the candidate controlling node being not the target controlling node, building a link with a first instance of the nodes of the logical chain where the candidate controlling node is located, to obtain the logical ring that has been updated.

In an illustrative embodiment, after the step of continuing to search for the controlling nodes along the logical ring downstream, till the candidate controlling node in the normal operation state is found, the method further comprises:
in response to the candidate controlling node being the target controlling node, reporting alarming information, wherein the alarming information is for indicating that the logical ring where the target controlling node is located malfunctions.

In an illustrative embodiment, in response to the fourth controlling node comprising the second controlling node, the method further comprises:
disconnecting a link with the second controlling node.

In an illustrative embodiment, the step of sending the second data packet to the second controlling node comprises:
by using an internal-memory protocol of a calculation quick-connection protocol, storing the second data packet into a server main-memory of the distributed system, to obtain a data copy;
performing jumbo-frame packaging processing to the second data packet, to obtain a target jumbo frame; and
transmitting the target jumbo frame to the second controlling node.

In an illustrative embodiment, the step of performing jumbo-frame packaging processing to the second data packet, to obtain the target jumbo frame comprises:
adding the second data packet into a buffer;
packaging data in the buffer to be a jumbo frame, to obtain the target jumbo frame; and
releasing the buffer.

In an illustrative embodiment, after the step of transmitting the target jumbo frame to the second controlling node, the method further comprises:
detecting whether packet loss happens in the target jumbo frame;
in response to packet loss happening in the target jumbo frame, by using a buffer-consistency protocol of the calculation quick-connection protocol, reading the data copy from the server main-memory; and
transmitting the data copy to the second controlling node.

In an illustrative embodiment, the step of transmitting the data copy to the second controlling node comprises:
splitting the data copy and packaging into a standard Ethernet frame; and
transmitting the standard Ethernet frame to the second controlling node.

In an illustrative embodiment, after the step of transmitting the standard Ethernet frame to the second controlling node, the method further comprises:
in response to the standard Ethernet frame having been successfully transmitted, detecting a network state of the target controlling node; and
in response to the network state reaching a target network state, resuming the jumbo-frame packaging processing to subsequent data packets.

In an illustrative embodiment, before the step of receiving the first data packet sent by the first controlling node, the method further comprises:
according to a quantity of the nodes comprised by the distributed system, determining M and quantities of the nodes comprised by the node sets;
according to M and the quantities of the nodes comprised by the node sets, dividing the nodes comprised by the distributed system, to obtain the node sets of the quantity M; and
building links between the node sets of the quantity M, to obtain the logical ring.

According to another embodiment of the present application, there is provided a distributed system, wherein nodes comprised by the distributed system are grouped into node sets of a quantity M, wherein M is greater than 1, a plurality of nodes that are comprised by each of the node sets are sequentially connected to obtain a logical chain having a direction, the logical chains of the quantity M are sequentially connected to obtain a logical ring having a direction, and a last one node of each of the logical chains is a controlling node; and
each of the controlling nodes serves as a target controlling node configured for implementing the steps according to any one of the process embodiments stated above.

According to another embodiment of the present application, there is provided an apparatus of node training for a distributed system, wherein the apparatus is applied in a target controlling node deployed in the distributed system, nodes comprised by the distributed system are grouped into node sets of a quantity M, wherein M is greater than 1, a plurality of nodes that are comprised by each of the node sets are sequentially connected to obtain a logical chain having a direction, the node sets of the quantity M are sequentially connected to obtain a logical ring having a direction, a last one node of each of the logical chains is a controlling node, the target controlling node refers to each of the controlling nodes, and the apparatus comprises:
a first receiving module configured for receiving a first data packet sent by a first controlling node, wherein the first controlling node refers to a preceding one controlling node of the target controlling node in the logical ring;
a first executing module configured for, by using the first data packet and a target data packet, executing a target training task of the target controlling node, to obtain a second data packet, wherein the target data packet carries training data of all of the nodes in a target node set where the target controlling node is located; and
a first sending module configured for sending the second data packet to a second controlling node, till the target controlling node has received training data of all of the controlling nodes of the distributed system, wherein the second controlling node refers to a next one controlling node of the target controlling node in the logical ring, and the training data of all of the controlling nodes of the distributed system and the target data packet are dispatched to the other nodes than the target controlling node in the target node set.

According to yet another embodiment of the present application, there is further provided a non-volatile readable storage medium, wherein the non-volatile readable storage medium stores a computer program, and the computer program is configured for, when being executed, implementing the steps according to any one of the process embodiments stated above.

According to still another embodiment of the present application, there is further provided an electronic device, wherein the electronic device comprises a memory and a processor, the memory stores a computer program, and the processor is configured for executing the computer program to implement the steps according to any one of the process embodiments stated above.

By using the present application, the target controlling node receives the first data packet sent by the preceding one controlling node connected to the target controlling node in the logical ring, i.e., the first controlling node, by using the first data packet and the training data of all of the nodes in the target node set where the target controlling node is located, executes the target training task to obtain the second data packet, and subsequently sends the second data packet to the second controlling node, whereby the second controlling node can use the training data of all of the nodes in the target node set where the target controlling node is located to perform the training. Because the target controlling node dispatches the target data packet that it receives to the other nodes than the target controlling node in the target node set, each of the nodes of the distributed system can obtain the training data of all of the nodes of the distributed system, which may solve the problem of a low efficiency of the node training of the distributed systems, to reach the effect of increasing the efficiency of the node training of the distributed system.

### BRIEF DESCRIPTION OF THE DRAWINGS

FIG. 1 is a block diagram of the hardware structure of a mobile terminal for a method of node training for a distributed system according to an embodiment of the present application;

FIG. 2 is a flow chart of a method of node training for a distributed system according to an embodiment of the present application;

FIG. 3 is a schematic diagram of the process of the sending of the first data packet by the first controlling node according to an embodiment of the present application;

FIG. 4 is a schematic diagram of the process of the updating of the logical ring according to an embodiment of the present application;

FIG. 5 is a schematic diagram of the process of the construction of the logical ring according to an embodiment of the present application;

FIG. 6 is a schematic diagram of the process of the generation of the second data packet according to an embodiment of the present application;

FIG. 7 is a structural block diagram of a distributed system according to an embodiment of the present application;

FIG. 8 is a structural block diagram of an apparatus of node training for a distributed system according to an embodiment of the present application; and

FIG. 9 is a structural block diagram of an electronic device according to an embodiment of the present application.

### DETAILED DESCRIPTION

The embodiments of the present application will be described in detail below with reference to the drawings and the embodiments.

It should be noted that the terms “first”, “second” and so on in the description, the claims and the drawings of the present application are intended to distinguish similar objects, and are not necessarily used to describe a particular order or sequence.

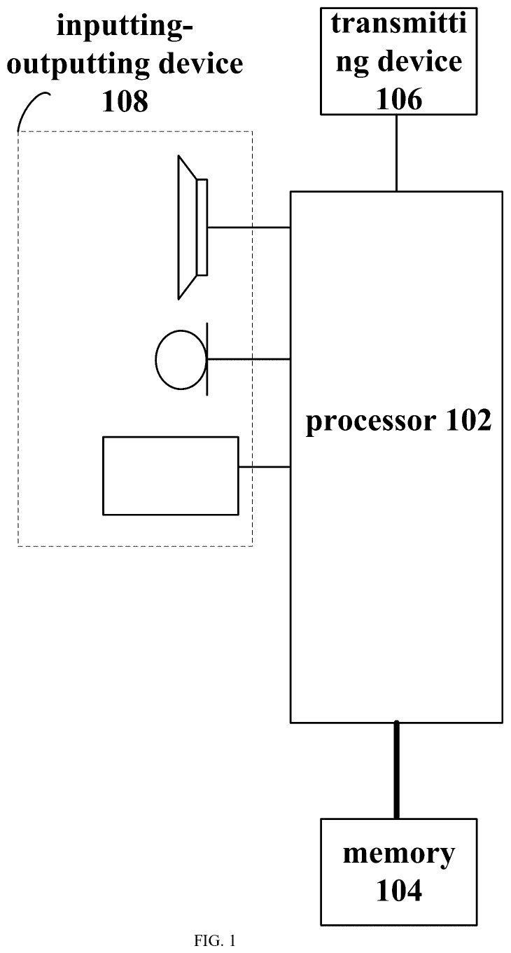

The process embodiments according to the embodiments of the present application may be implemented in a server device or a similar computing device. Taking the case as an example in which they are implemented in a server device, FIG. 1 is a block diagram of the hardware structure of a server device for a method of node training for a distributed system according to an embodiment of the present application. As shown in FIG. 1, the server device may comprise one or more (FIG. 1 shows merely one) processors 102 (the processors 102 may include but are not limited to a processing device such as a microprocessor MCU or a programmable logic device FPGA) and a memory 104 configured for storing data. The server device may further comprise a transmitting device 106 for the communicate function and an inputting-outputting device 108. A person skilled in the art can understand that the structure shown in FIG. 1 is merely illustrative, and does not limit the structure of the server device. For example, the server device may also comprise more or fewer components than those shown in FIG. 1, or have a different configuration from that shown in FIG. 1.

The memory 104 may be configured for storing a computer program, for example, the software programs and modules of an application software, for example, a computer program corresponding to the method of node training for a distributed system according to the embodiments of the present application. The processors 102 execute the computer program stored in the memory 104, so as to execute various function applications and data processing, i.e., implementing the method stated above. The memory 104 may include a high-speed random access memory, and may also include a non-volatile memory, for example, one or more magnetic storing devices, flash memories, or other non-volatile solid-state memories. In some embodiments, the memory 104 may include memories provided remotely to the processors 102, and those remote memories may be connected to the server device via a network. Examples of the network include but are not limited to the Internet, an enterprise intranet, a local area network, a mobile communication net and a combination thereof.

The transmitting device 106 is configured for receiving or emitting data via a network. The alternative examples of the network may include a wireless network supplied by the communication supplier of the server device. In an embodiment, the transmitting device 106 comprises a network adaptor (Network Interface Controller, referred to for short as NIC), which may be connected to other network devices via a base station so as to communicate with the Internet. In an embodiment, the transmitting device 106 may be a Radio Frequency (referred to for short as RF) module, which is configured for communicating with the Internet wirelessly.

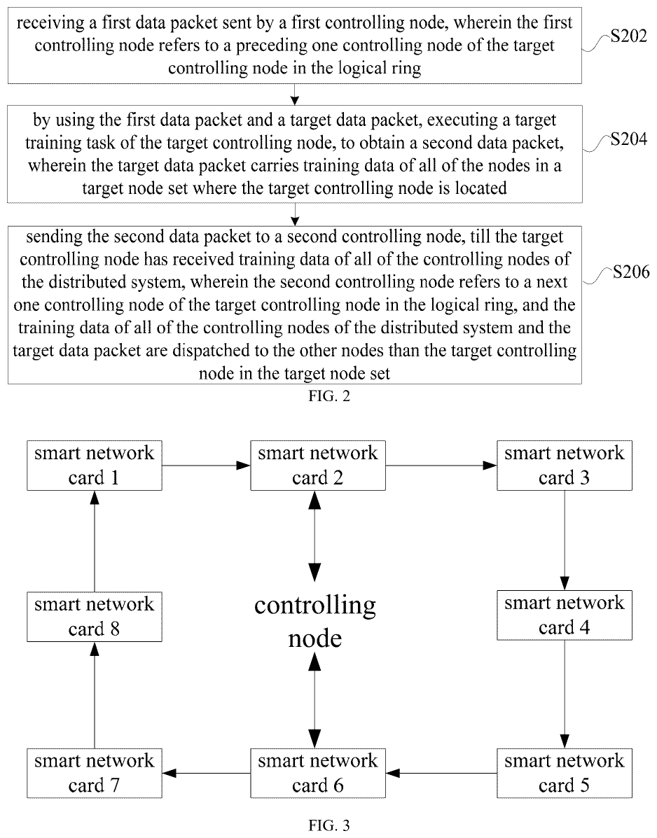

The present embodiment provides a method of node training for a distributed system, wherein the method is applied in a target controlling node deployed in the distributed system, nodes comprised by the distributed system are grouped into node sets of a quantity M, wherein M is greater than 1, a plurality of nodes that are comprised by each of the node sets are sequentially connected to obtain a logical chain having a direction, the node sets of the quantity M are sequentially connected to obtain a logical ring having a direction, the last one node of each of the logical chains is a controlling node, and the target controlling node refers to each of the controlling nodes. FIG. 2 is a flow chart of a method of node training for a distributed system according to an embodiment of the present application. As shown in FIG. 2, the flow comprises the following steps:
Step S202: receiving a first data packet sent by a first controlling node, wherein the first controlling node refers to a preceding one controlling node of the target controlling node in the logical ring;
Step S204: by using the first data packet and a target data packet, executing a target training task of the target controlling node, to obtain a second data packet, wherein the target data packet carries training data of all of the nodes in a target node set where the target controlling node is located; and
Step S206: sending the second data packet to a second controlling node, till the target controlling node has received training data of all of the controlling nodes of the distributed system, wherein the second controlling node refers to a next one controlling node of the target controlling node in the logical ring, and the training data of all of the controlling nodes of the distributed system and the target data packet are dispatched to the other nodes than the target controlling node in the target node set.

By using the above steps, the target controlling node receives the first data packet sent by the preceding one controlling node connected to the target controlling node in the logical ring, i.e., the first controlling node, by using the first data packet and the training data of all of the nodes in the target node set where the target controlling node is located, executes the target training task to obtain the second data packet, and subsequently sends the second data packet to the second controlling node, whereby the second controlling node can use the training data of all of the nodes in the target node set where the target controlling node is located to perform the training. Because the target controlling node dispatches the target data packet that it receives to the other nodes than the target controlling node in the target node set, each of the nodes of the distributed system can obtain the training data of all of the nodes of the distributed system, which may solve the problem of a low efficiency of the node training of the distributed systems, to reach the effect of increasing the efficiency of the node training of the distributed system.

Optionally, in the present embodiment, the method of node training for a distributed system according to the present application has extensive usage scenarios, which may, without limitation, include a plurality of servers form a distributed system, wherein each of the servers is a node of the distributed system; a plurality of servers deployed with a smart network card (Smart NIC, Smart Network Interface Card) form a distributed system, wherein each of the smart network cards is a node of the distributed system; a plurality of servers deployed with a GPU (Graphics Processing Unit) form a distributed system, wherein each of the GPUs is a node of the distributed system; and so on. In the following embodiments, the method of node training for a distributed system may, without limitation, be described by taking the scene as an example in which a plurality of servers deployed with a smart network card form a distributed system, wherein each of the smart network cards is a node of the distributed system, but the usage scenario is not limited, whereby any process of the node training of a distributed system may use the method of node training for a distributed system according to the present application.

Optionally, in the present embodiment, the method of node training for a distributed system is applied in the target controlling node deployed in the distributed system. The plurality of nodes comprised by the distributed system may, without limitation, be completely the same nodes. For example, GPUs of the equal parameters are deployed in a plurality of servers, wherein each of the GPUs is one node; smart network cards of the equal parameters are deployed in a plurality of servers, wherein each of the smart network cards is one node; and so on. Alternatively, the nodes of the distributed system may also differ to a certain extent. For example, GPUs of unequal parameters are deployed in a plurality of servers, wherein each of the GPUs is one node; smart network cards of unequal parameters are deployed in a plurality of servers, wherein each of the smart network cards is one node; and so on.

Optionally, taking the case as an example in which the distributed system comprises a node 1, a node 2 and so on to a node 16, the dividing the plurality of nodes into the node sets of the quantity M will be described. The 16 nodes may, without limitation, be divided into the node sets of the quantity M evenly. Taking the case as an example in which M is 4, each 4 nodes are grouped into one node set, whereby the 16 nodes are divided into 4 node sets. Alternatively, the 16 nodes may also, without limitation, be divided into the node sets of the quantity M according to the practical demand. For example, the first 4 nodes are grouped into one node set, 5 nodes among the remaining nodes are grouped into a second node set, 3 nodes among the remaining nodes are grouped into one node set, and the final 4 nodes are grouped into one node set, whereby the 16 nodes are divided into 4 node sets. The above-described demand may include but is not limited to the demands on the data processing capacities of the nodes, the node training of the distributed system, and so on.

Regarding the node sets, each of the node sets comprises one controlling node. The plurality of nodes that are comprised by the node set are sequentially connected to obtain a logical chain having a direction, and the last one node of the logical chain is the controlling node.

Regarding the node sets of the quantity M, the sequentially connecting the node sets of the quantity M to obtain the logical ring having the direction may, without limitation, be performed in multiple modes. For example, the logical chains are sequentially connected head-to-tail in a direction to obtain the logical ring having the direction, wherein the logical ring comprises all of the nodes of the node sets of the quantity M. Alternatively, the controlling nodes of the logical chains are connected in a direction to obtain the logical ring having the direction, wherein the logical ring comprises the controlling nodes of the quantity M of the node sets of the quantity M.

Optionally, in the present embodiment, the distributed system comprises the node sets of the quantity M, and each of the node sets comprises 1 controlling node; in other words, the distributed system comprises the controlling nodes of the quantity M. Each of the controlling nodes may, without limitation, be determined to be the target controlling node to implement the method of node training for a distributed system to realize the training of each of the nodes of the distributed system.

Optionally, in the present embodiment, the nodes of the distributed system may, without limitation, be connected to each other to form the logical ring having the direction in multiple modes, for example, by using a device such as an exchange. The controlling nodes may, without limitation, be set in multiple modes. For example, each of the nodes comprised by the distributed system is deployed with a hardware or software device that can implement the function of a controlling node, and, if it is required to set a node to be the controlling node, the corresponding device required to be set to be the controlling node is started up. Alternatively, a controlling node of the distributed system is deployed with a hardware or software device that can implement the function of a controlling node. The setting the last one node of the logical chain to be the controlling node may, without limitation, be performed in multiple modes. For example, each of the nodes comprised by the distributed system is deployed with a hardware or software device that can implement the function of a controlling node, and the hardware or software device of the last one node of the logical chain that is set to be the controlling node is started up. Alternatively, a hardware or software device that has the function of the controlling node is used in the last one node of the logical chain.

In the technical solution provided by the step S202, the first controlling node belongs to a node set, and the node set that the first controlling node belongs to may, without limitation, comprise a plurality of nodes. The training data of all of the nodes may, without limitation, be sequentially transmitted to the first controlling node in the direction of the logical chain, and the first controlling node subsequently, in the direction of the logical ring, transmits to the target controlling node the training datum of the first controlling node itself and the training data of all of the nodes in the node set that the first controlling node belongs to. In other words, the first data packet sent by the first controlling node may, without limitation, comprise the training datum of the first controlling node itself and the training data of all of the nodes in the node set that the first controlling node belongs to.

In an illustrative embodiment, before the step of receiving the first data packet sent by the first controlling node, the step of sending the first indicating information to the third controlling node in the distributed system may, without limitation, be performed in the following mode:
detecting operation states of all of the nodes in the target node set; and
in response to a node the operation state of which is an abnormal operation state existing in the target node set, sending first indicating information to a third controlling node in the distributed system, wherein the first indicating information is for indicating that the target node set is in the abnormal operation state, and the third controlling node refers to a controlling node other than the target controlling node in the distributed system.

Optionally, in the present embodiment, the target node set is the node set where the target controlling node is located, and the operation states of the nodes in the target node set may, without limitation, include the operation state of each of the nodes itself, the operation states of the transmission links between the nodes, and so on.

Optionally, in the present embodiment, the step of detecting the operation states of all of the nodes in the target node set may, without limitation, be performed in multiple modes, for example, determining the operation states of all of the nodes by acquiring the delays of the nodes, determining the operation states of all of the nodes by acquiring the bandwidths of the nodes, determining the operation states of all of the nodes by acquiring the packet loss probabilities of the nodes, determining the operation states of all of the nodes by acquiring the throughputs of the nodes, determining the operation states of all of the nodes by acquiring the Jitters (the deviation from the ideal time of an event) of the nodes, determining the operation states of all of the nodes by acquiring the reliabilities of the nodes, and so on.

Optionally, in the present embodiment, the node the operation state of which is the abnormal operation state may, without limitation, be used for indicating that the node is abnormal, or used for indicating that the transmission link between the node and the next one node is abnormal, and so on.

Optionally, in the present embodiment, in the distributed system, the controlling nodes of the quantity M may, without limitation, have the function of intercommunication therebetween. In the process of the node training of the distributed system, any controlling node may, without limitation, be determined to be the target controlling node. The target controlling node may, without limitation, be configured for detecting the operation states of all of the nodes comprised by the target node set that it belongs to. If it has been detected by the target controlling node that the target node set comprises a node in the abnormal operation state, the target controlling node may, without limitation, be configured for sending to the other controlling nodes comprised by the distributed system the first indicating information configured for indicating that the target node set is in the abnormal operation state.

In other words, each of the controlling nodes in the distributed system may be configured for detecting whether a node in the abnormal operation state exists in the node set where it is located, and, if a node in the abnormal operation state exists, informing the other controlling nodes.

Optionally, in the present embodiment, the third controlling node may, without limitation, include all of the controlling nodes in the distributed system other than the controlling node in the node set where the node in the abnormal operation state is located.

Optionally, in the present embodiment, the first indicating information may, without limitation, be used for indicating the node in the abnormal operation state, or used for indicating the target node set where the node in the abnormal operation state is located, and so on. The first indicating information may, without limitation, include the identifier of the node in the abnormal operation state, the identifier of the target node set where the node in the abnormal operation state is located, the identifiers of the starting node and the controlling node of the logical chain corresponding to the target node set, the abnormality reason of the abnormal operation state, and so on.

Optionally, in the present embodiment, the third controlling node may, without limitation, acquire the target node set in the abnormal operation state by parsing the first indicating information. For example, the third controlling node acquires the target node set in the abnormal operation state by parsing the identifier of the target node set carried by the first indicating information. Alternatively, the third controlling node, by parsing the identifier of the node in the abnormal operation state carried by the first indicating information, determines the target node set in the abnormal operation state according to the identifier of the node.

In an illustrative embodiment, in response to a node the operation state of which is an abnormal operation state existing in the target node set, the following operation may, without limitation, be performed:
disconnecting a link with the second controlling node.

Optionally, in the present embodiment, the target node set where the target controlling node is located may, without limitation, comprise a plurality of nodes, the plurality of nodes are sequentially connected to obtain the logical chain having a direction, the target controlling node is at the tail of the current logical chain and connected to the next one node set, and the next one node set comprises the second controlling node. If the target node set where the target controlling node is located comprises a node in the abnormal operation state, the target controlling node may, without limitation, disconnect the link with the second controlling node, so that the second controlling node can build a link with a node set in the normal operation state to form a new logical ring, whereby the newly connected logical ring can normally operate.

In an illustrative embodiment, the step of receiving the first data packet sent by the first controlling node may, without limitation, be performed in the following mode:
after the operation states of all of the nodes in the target node set have been detected, in response to all of the operation states of the nodes in the target node set being a normal operation state, receiving the first data packet sent by the first controlling node.

Optionally, in the present embodiment, if all of the operation states of all of the nodes comprised by the target node set are the normal operation state, it is considered that the target node set is in the normal operation state, and the target controlling node may, without limitation, be configured for receiving the first data packet sent by the first controlling node.

Optionally, in the present embodiment, the first controlling node may, without limitation, send the first data packet in multiple cases. For example, the first controlling node sends the first data packet in real time; in other words, the first controlling node, immediately when has completed the packaging of the first data packet, sends the first data packet to the target controlling node. Alternatively, the first data packet may also be acquired actively by the target controlling node from the first controlling node if the target controlling node has confirmed that the target node set is in the normal operation state.

In an illustrative embodiment, the step of detecting the operation states of all of the nodes in the target node set may, without limitation, be performed in the following mode:
detecting response times of all of the nodes in the target node set; and
determining a node in the target node set the response time of which is greater than or equal to a time threshold to be the node the operation state of which is the abnormal operation state.

Optionally, in the present embodiment, the response time of each of the nodes in the target node set may, without limitation, be the duration by which each of the nodes in the target node set responds to the target controlling node and transmits its training datum. The response time of each of the nodes may, without limitation, be influenced by multiple factors such as the network. If a node is influenced and therefore its response time is greater than or equal to the time threshold, the operation state of the node may, without limitation, be determined to be the abnormal operation state.

Optionally, in the present embodiment, the time threshold may, without limitation, be a preset fixed parameter, or be a parameter value that varies in real time. For example, if the network environment is better, the time threshold is properly set to be higher. Alternatively, if the network environment is poorer, the time threshold is controlled to be in a certain range.

In an illustrative embodiment, an example of the process of the sending of the first data packet by the first controlling node is provided. FIG. 3 is a schematic diagram of the process of the sending of the first data packet by the first controlling node according to an embodiment of the present application. As shown in FIG. 3, smart network cards serve as the nodes of the distributed system, the distributed system comprises a smart network card 1, a smart network card 2, a smart network card 3 and so on to a smart network card 8, and the smart network card 2 and the smart network card 6 are used as the controlling nodes. Taking the case as an example in which the smart network card 2 serves as a target smart network card, the first controlling node is the smart network card 6, and the method is described as follows: the smart network cards are connected by exchanges to form a ring topology, and the smart network card 2 receives the first data packet sent by the smart network card 6, and, by using the first data packet and the target data packet of the smart network card 2, executes the target training task of the smart network card 2 to obtain the second data packet.

In the technical solution provided by the step S204, the target training task of the target controlling node may, without limitation, be used for performing the node training to the target controlling node and each of the nodes in the target node set. For example, the target controlling node, according to the target training task, determines the operation executed to the first data packet and the target data packet, and the mode of the node training to the target controlling node and each of the nodes in the target node set by using the operation result. The operation executed to the first data packet and the target data packet according to the target training task of the target controlling node may, without limitation, be a calculation operation, for example, addition, subtraction and division. The calculation operation in the target training task may, without limitation, be determined according to the mode of the node training of each of the nodes in the distributed system.

Optionally, in the present embodiment, the second data packet is obtained by executing the target training task of the target controlling node to the first data packet and the target data packet, for example, performing addition operation to the first data packet and the target data packet, and determining the result obtained by the calculation to be the second data packet.

Optionally, in the present embodiment, the first data packet and the target data packet may, without limitation, be expressed in multiple modes, for example, CP16, CP32, FP16 and CP32. The different expression modes may, without limitation, be converted therebetween according to the usage modes. For example, the target data packet is stored in the mode of CP32, the first data packet is transmitted in the mode of CP16, and the target controlling node, when has received the first data packet, may, without limitation, convert the first data packet of CP16 into the CP32 format and subsequently execute the target training task.

Optionally, the usage modes of CP16, CP32, FP16 and CP32 will be described below. FP16 uses 16 bits to represent one floating-point number, of which 1 bit represents the sign symbol, 5 bits represent the exponent (Exponent), and 10 bits represent the mantissa (Fraction). The FP 16 standard is a data-precision standard supported by GPU devices. The maximum value that FP16 normalized numbers can represent is 0 11110 1111 1111 11=1.11 1111 1111*2¹⁵=(2-2⁽⁻¹⁰⁾)*2¹⁵=65536⁻³²=65504, and therefore FP16 normalized numbers can represent large numerical values.

In the case in which in the tasks of deployment and fine adjustment of deep-learning models an excessively large numerical value does not emerge, a new mode representing 16-bit floating-point numbers and 32-bit floating-point numbers may, without limitation, be employed, including CP 16, wherein 1 bit represents the sign bit, 3 bits represent the exponent, and 12 bits represent the mantissa; and CP32, wherein 1 bit represents the sign bit, 3 bits represent the exponent, and 28 bits represent the mantissa.

The representation mode of the CP16 and CP32 data precisions reduce the representation range of integers, and increase the precision representation degree of decimals, which more meets the case of the data-precision representation of deep neural networks in terms of weight and gradient, and facilitates to increase the model training precision. Because CP16 and CP32 have equal bit quantities at the sign bit and the exponent bits, in the device hardware logic the conversion between CP32 and CP16 (processes of data compression and decompression) can directly perform operations of “zeroizing” and “truncation”, which avoids the data-precision conversion of the modes such as affine transformation and proportion scaling, facilitates to simplify the calculation logic, and increases the efficiency of the data-precision conversion.

Optionally, in the present embodiment, the first data packet and the target data packet may, without limitation, be compressed data packets. Before executing the target training task, the first data packet and the target data packet may, without limitation, be stored into a buffer region to be decompressed. The target training task may, without limitation, comprise within the buffer region, performing data operation to the first data packet and the target data packet, determining whether the operation has been completed, if the operation has been completed, performing reduction calculation, and compressing the obtained data as the second data packet.

In an illustrative embodiment, before the step of, by using the first data packet and the target data packet, executing the target training task of the target controlling node, the obtaining the target data packet may, without limitation, be performed in the following mode:
receiving a reference data packet sent by a preceding one node of the target controlling node in the target node set, wherein the reference data packet refers to a data packet that is formed by transmitting and operating training datum of each of the nodes in the target node set sequentially in a target logical chain of the target node set and is formed in the preceding one node; and
by using the reference data packet and a target training datum of the target controlling node, executing the target training task, to obtain the target data packet.

Optionally, in the present embodiment, the target node set may, without limitation, comprise the controlling node and a plurality of non-controlling nodes, and the non-controlling nodes are sequentially connected to form a logical chain having a direction and are subsequently connected to the controlling node at the tail end to obtain the complete logical chain. The non-controlling nodes may, without limitation, be configured for, when one time of the training task has been completed, transmitting the training data in the direction indicated by the logical chain. The controlling node may, without limitation, be configured for receiving the training data transmitted by the non-controlling node connected thereto and subsequently executing the training task. Each of the nodes in the complete logical chain may, without limitation, realize the training of the node by executing the training task, and the training task may, without limitation, be used for indicating the operation executed by each of the nodes to the training data that it currently receives and the training data that it itself has already stored. In other words, the preceding one non-controlling node of the target controlling node, after processing according to the training task, obtains a data packet, i.e., the reference data packet, the non-controlling node transmits the data packet to the target controlling node, and the target controlling node, after has received the reference data packet, subsequently uses the reference data packet to execute the training task.

Optionally, in the present embodiment, the target training datum of the target controlling node may, without limitation, be the data packet obtained after the target controlling node has completed the previous one training task, or the target training datum may, without limitation, be an initial training datum dispatched by the target controlling node.

Optionally, in the present embodiment, taking the case as an example in which the logical chain comprises the node 1, the node 2, the node 3 and the target controlling node, the connection direction of the logical chain is the node 1 connected to the node 2 connected to the node 3 finally connected to the target controlling node, and each of the nodes has its initial training datum and training task, the target data packet of the target controlling node may, without limitation, be obtained in the following mode:

The node 1 compresses its training datum 1 to obtain a data packet 1, and transmits the data packet 1 to the node 2. The node 2 receives the data packet 1 sent by the node 1, decompresses the data packet 1, and subsequently processes the data packet 1 and a training datum 2 of the node 2 itself according to a training task 1 of the node 2 to obtain a data packet 2.

The node 2 transmits the data packet 2 to the node 3. The node 3 receives the data packet 2 sent by the node 2, decompresses the data packet 2, and subsequently processes the data packet 2 and a training datum 3 of the node 3 itself according to a training task 2 of the node 3 to obtain a data packet 3. The node 3 transmits the data packet 3 to the target controlling node.

The target controlling node receives the data packet 3 (the reference data packet), decompresses the data packet 3, and subsequently processes the data packet 3 and a training datum 4 of the target controlling node itself (the target training datum) according to a training task 3 of the target controlling node (the target training task) to obtain a data packet 4 (the target data packet).

In the technical solution provided by the step S206, the second controlling node refers to the next one controlling node of the target controlling node in the logical ring. For example, taking the case as an example in which the controlling nodes in the logical chains are sequentially connected to obtain the logical ring, the second controlling node refers to the next one controlling node that is connected to the target controlling node in the logical ring. Taking the case as an example in which the logical chains are sequentially connected head-to-tail to obtain the logical ring that comprises all of the nodes, the second controlling node refers to the controlling node comprised by the next one node set of the target node set where the target controlling node is located.

Optionally, in the present embodiment, the target controlling node, when has obtained the second data packet, is required to send the second data packet to the other data nodes connected in the logical ring to perform the synchronization of the data packet. The target controlling node transmits to the next one node in the direction of the logical ring, so that the next one node can receive the data packet for the training. The next one node may, without limitation, be the next one controlling node of the target controlling node, i.e., the second controlling node, or the next one node may, without limitation, be a non-controlling node comprised by the node set that the next one controlling node belongs to. For example, the target controlling node transmits the second data packet to the second controlling node, the second controlling node may, without limitation, be configured for using the second data packet to execute the training task, the second controlling node is further configured for transmitting the second data packet to all of the non-controlling nodes that it controls, subsequently each of the non-controlling nodes uses the second data packet to execute the training task, till all of the nodes in the logical ring have received the complete training data. Further, when all of the controlling nodes in the distributed system have received the complete training data, it is considered that the node training of the distributed system has been completed, wherein the complete training data include the training data of all of the nodes in the distributed system.

Optionally, in the present embodiment, because the second data packet may, without limitation, comprise the training data of the target controlling node and the controlling node preceding the target controlling node, the second data packet may, without limitation, be packaged, compressed, and subsequently sent to the second controlling node in the corresponding frame format. The frame format may, without limitation, include jumbo frame, Ethernet frame and ultra-long frame.

In an illustrative embodiment, before the step of sending the second data packet to the second controlling node, the obtaining the logical ring that has been updated may, without limitation, be performed in the following mode:
receiving second indicating information sent by a fourth controlling node in the distributed system, wherein the second indicating information is for indicating that the node set where the fourth controlling node is located is in an abnormal operation state; and
in response to the fourth controlling node comprising the second controlling node, building a link with a first instance of the nodes of the logical chain that has a lowest distance to the target controlling node in the logical ring and is in a normal operation state, to obtain a logical ring that has been updated, wherein the logical chains of the quantity M are sequentially connected to obtain the logical ring having the direction.

Optionally, in the present embodiment, the fourth controlling node refers to the controlling node comprised by the logical chain in the abnormal operation state in the logical ring. The second indicating information may, without limitation, be used for indicating the node in the abnormal operation state, or used for indicating the target node set where the node in the abnormal operation state is located, and so on. The second indicating information may, without limitation, include the identifier of the node in the abnormal operation state, the identifier of the target node set where the node in the abnormal operation state is located, the identifiers of the starting node and the controlling node of the logical chain corresponding to the target node set, the abnormality reason of the abnormal operation state, and so on.

Optionally, in the present embodiment, the second indicating information may, without limitation, be used for indicating one or more node sets in the abnormal operation state, and the fourth controlling node may, without limitation, refer to the controlling nodes corresponding to one or more node sets in the abnormal operation state.

Optionally, in the present embodiment, the target node set in the abnormal operation state may, without limitation, be acquired by parsing the second indicating information, for example, acquiring the target node set in the abnormal operation state by parsing the identifier of the target node set carried by the second indicating information. Alternatively, the second indicating information carries the identifier of the node in the abnormal operation state, and the target node set in the abnormal operation state is determined according to the identifier of the node.

Optionally, in the present embodiment, the second indicating information sent by the fourth controlling node may, without limitation, be sent to limited nodes. For example, the fourth controlling node sends a second indicating signal to the preceding one controlling node and the next one controlling node that are connected thereto. Alternatively, the second indicating information sent by the fourth controlling node may also be sent to nodes not limited. For example, the fourth controlling node sends a second indicating signal to all of the nodes, and the controlling nodes receive and parse the second indicating signal to perform the subsequent operations.

Optionally, in the present embodiment, the second controlling node refers to the next one controlling node of the target controlling node in the logical ring. After the target controlling node has received the second indicating information for indicating that the second controlling node is in the abnormal operation state, the target controlling node may, without limitation, be configured for disconnecting the link with the second controlling node, and building a link with the next one controlling node of the second controlling node, to obtain the logical ring that has been updated.

In an illustrative embodiment, the step of sending the second data packet to the second controlling node may, without limitation, be performed in the following mode:
after the logical ring that has been updated has been obtained, sending the second data packet to a next one controlling node of the target controlling node in the logical ring that has been updated.

Optionally, in the present embodiment, if the second controlling node is in the abnormal operation state, the target controlling node, by disconnecting the link with the second controlling node and building a new link with a controlling node in the normal operation state, realizes constructing a normally operating logical ring, and the target controlling node is configured for, in the logical ring that has been updated, sending the second data packet to the next one controlling node of the target controlling node.

In an illustrative embodiment, in response to the fourth controlling node comprising the second controlling node, the step of building the link with the first instance of the nodes of the logical chain that has the lowest distance to the target controlling node in the logical ring and is in the normal operation state may, without limitation, be performed in the following mode:
searching for the second controlling node in the fourth controlling node;
in response to the second controlling node being found, searching for a next one controlling node of the second controlling node in the fourth controlling node; and
in response to the next one controlling node of the second controlling node being not found, building a link with a first instance of the nodes of the logical chain where the next one controlling node of the second controlling node is located, to obtain the logical ring that has been updated.

Optionally, in the present embodiment, the node set where the fourth controlling node is located is in the abnormal operation state, and after the target controlling node has received the second indicating information sent by the fourth controlling node, the target controlling node may, without limitation, by parsing the second indicating information, determining whether the fourth controlling node indicated by the second indicating information is the second controlling node connected to the target controlling node.

Optionally, in the present embodiment, the fourth controlling node may, without limitation, include the controlling node in the node set in the abnormal operation state. The logical ring may, without limitation, comprise a plurality of controlling nodes. During the operation of the logical ring, one or more nodes may, without limitation, have abnormality. If one or more nodes have abnormality, the node set where it is located is determined to be the node set in the abnormal operation state, and the controlling node corresponding thereto is determined to be the fourth controlling node.

Optionally, in the present embodiment, if the fourth controlling node comprises the second controlling node, the method may, without limitation, comprise, in the direction shown by the logical ring, determining whether the fourth controlling node comprises the next one controlling node of the second controlling node. In other words, if the node set in the abnormal operation state is the node set where the second controlling node is located, the method may, without limitation, comprise, in the direction shown by the logical ring, determining whether the next one controlling node of the second controlling node is the node set in the abnormal operation state.

Optionally, regarding the target controlling node in the logical ring, the second controlling node refers to the next one controlling node of the target controlling node in the logical ring. If the node set where the second controlling node is located is in the abnormal operation state, the target controlling node may, without limitation, by disconnecting the link with the node set in the abnormal operation state and building a new link with a node set in the normal operation state, obtain the logical ring that has been updated, to ensure that the logical ring that has been updated can normally operate. Therefore, the target controlling node may, without limitation, by, in the direction of the logical ring, sequentially detecting whether the node set where the next one controlling node is located is in the normal operation state, obtain the logical ring that has been updated.

The mode of, in the direction of the logical ring, sequentially detecting whether the node set where the next one controlling node is located is in the normal operation state may, without limitation, comprise, from the fourth controlling node, sequentially searching for whether each of the node sets exists in the second indicating information sent by the fourth controlling node, till a node set that does not exist in the second indicating information is found, and building a new link therewith.

Optionally, in the present embodiment, if the next one controlling node of the second controlling node is not found, the target controlling node may, without limitation, by building a link with a node set in the normal operation state, construct the logical ring that has been updated. For example, the target controlling node builds a link with the controlling node in a node set in the normal operation state to obtain the logical ring that has been updated. Alternatively, the target controlling node builds a link with the first instance of the nodes in the logical chain of a node set in the normal operation state, to obtain the logical ring that has been updated.

In an illustrative embodiment, after the step of searching for the next one controlling node of the second controlling node in the fourth controlling node, the obtaining the logical ring that has been updated may, without limitation, be performed in the following mode:
in response to the next one controlling node of the second controlling node being found, continuing to search for the controlling nodes along the logical ring downstream, till a candidate controlling node in the normal operation state is found; and
in response to the candidate controlling node being not the target controlling node, building a link with a first instance of the nodes of the logical chain where the candidate controlling node is located, to obtain the logical ring that has been updated.

Optionally, in the present embodiment, the candidate controlling node refers to the controlling node in the next one node set in the normal operation state of the target controlling node in the logical ring, and the second controlling node refers to the next one controlling node of the target controlling node in the logical ring. If the node set where the second controlling node is located is in the abnormal operation state, the target controlling node may, without limitation, by disconnecting the link with the node set in the abnormal operation state and building a new link with the candidate controlling node in the normal operation state, obtain the logical ring that has been updated, to ensure that the logical ring that has been updated can normally operate. Therefore, the target controlling node may, without limitation, by, in the direction of the logical ring, sequentially detecting whether the node set where the next one controlling node is located is in the normal operation state, obtain the candidate controlling node.

Optionally, in the present embodiment, if the candidate controlling node is not the target controlling node, the target controlling node may, without limitation, by building a link with the node set where the candidate controlling node is located, construct the logical ring that has been updated. For example, the target controlling node builds a link with the candidate controlling node to obtain the logical ring that has been updated. Alternatively, the target controlling node builds a link with the first instance of the nodes in the logical chain of the node set where the candidate controlling node is located, to obtain the logical ring that has been updated.

In an illustrative embodiment, after the step of continuing to search for the controlling nodes along the logical ring downstream, till the candidate controlling node in the normal operation state is found, the step of reporting the alarming information may, without limitation, be performed in the following mode:
in response to the candidate controlling node being the target controlling node, reporting alarming information, wherein the alarming information is for indicating that the logical ring where the target controlling node is located malfunctions.

Optionally, in the present embodiment, the candidate controlling node refers to the controlling node in the next one node set in the normal operation state of the target controlling node in the logical ring. If, in the logical ring, merely the node set where the target controlling node is located is in the normal operation state, it is obtained that the candidate controlling node and the target controlling node are the same one controlling node, and therefore it is required to alarm.

Optionally, in the present embodiment, it may, without limitation, be indicated by reporting the alarming information that the logical ring malfunctions, for example, by, by using the alarming information, notifying an administrator that the logical ring where the target controlling node is located malfunctions, the logical ring cannot be repaired automatically, and an intervention operation is required.

In an illustrative embodiment, in response to the fourth controlling node comprising the second controlling node, the following operation may, without limitation, be performed:
disconnecting a link with the second controlling node.

Optionally, in the present embodiment, if the node set where the next one controlling node connected to the target controlling node, i.e., the second controlling node, is located is in the abnormal operation state, the target controlling node may, without limitation, by disconnecting the link with the second controlling node and subsequently building a link with the controlling node in the next one node set that is in the normal operation state, obtain the logical ring that has been updated.

In an illustrative embodiment, the step of sending the second data packet to the second controlling node may, without limitation, be performed in the following mode:
by using an internal-memory protocol of a calculation quick-connection protocol, storing the second data packet into a server main-memory of the distributed system, to obtain a data copy;
performing jumbo-frame packaging processing to the second data packet, to obtain a target jumbo frame; and
transmitting the target jumbo frame to the second controlling node.

Optionally, in the present embodiment, the second data packet is obtained by executing the target training task of the target controlling node to the first data packet and the target data packet, and the target controlling node, before sending the second data packet to the second controlling node, may, without limitation, store the second data packet to the server main-memory of the distributed system to realize backing-up of the second data packet.

Optionally, the nodes in the distributed system may, without limitation, be Type-2 devices of CXL (Compute Express Link, calculation quick-connection protocol), for example, GPU and FPGA (Field-Programmable Gate Array). Because the Type-2 devices do not only have the consistent cache, but also have the capacity of connecting to the internal memories of the devices, taking the case as an example in which the nodes in the distributed system are Type-2 devices, the storage protocol (CXL. men) in the calculation quick-connection protocol may, without limitation, be used to store the second data packet to the server main-memory of the distributed system to realize the backing-up of the second data packet.

Optionally, in the present embodiment, the data copy refers to the data that are obtained after storing the second data packet to the server main-memory of the distributed system.

Optionally, in the present embodiment, the jumbo-frame packaging processing to the second data packet reduces the quantity of the gradient data packets in the network, and reduces the additional overhead for the processing of the packet headers by the network devices.

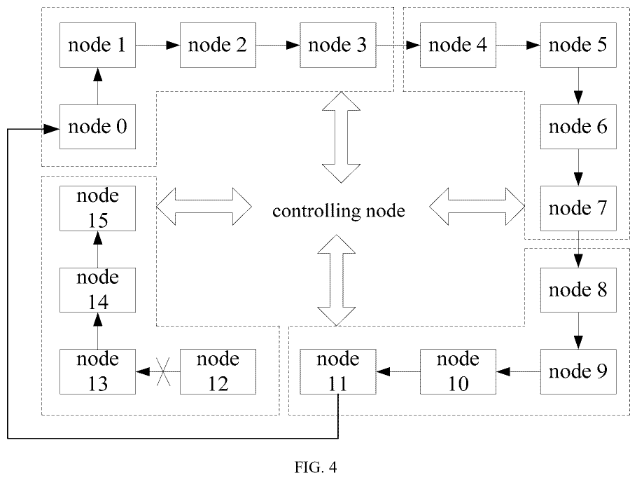

In an illustrative embodiment, an example of the process of the updating of the logical ring is provided. FIG. 4 is a schematic diagram of the process of the updating of the logical ring according to an embodiment of the present application. As shown in FIG. 4, taking the case as an example in which a smart network card 0 to a smart network card 15 are used as the nodes of the distributed system, the transmission link between a smart network card 12 and a smart network card 13 has abnormality, and the controlling nodes include a smart network card 3, a smart network card 7, a smart network card 11 and the smart network card 15, the updating of the logical ring may, without limitation, be performed in the following mode:

The smart network card 15 is determined to be the target controlling node, the smart network card 15 detects the operation states of the smart network card 12, the smart network card 13, a smart network card 14 and the smart network card 15 (all of the nodes in the target node set), to obtain that the transmission link between the smart network card 12 and the smart network card 13 has abnormality, and the smart network card 15 sends the first indicating information to the smart network card 3, the smart network card 7 and the smart network card 11 in the distributed system and disconnects the link with the smart network card 3.

The smart network card 11 is determined to be the target controlling node, the smart network card 11 receives the second indicating information sent by the smart network card 15 in the distributed system, wherein the second indicating information is used for indicating that the node set where the smart network card 15 is located is in the abnormal operation state, and the smart network card 11 builds a link with the first instance of the nodes of the logical chain that has the lowest distance to the smart network card 11 in the logical ring and is in the normal operation state, i.e., the smart network card 3, to obtain the logical ring that has been updated, and continues the calculation of the current training task.

When the network connection is interrupted or the hardware requires being replaced, the nodes in the distributed system may automatically reconstruct the connection to continue the calculation of the current training task, thereby preventing waste of the computational resource and time cost on waiting.

In an illustrative embodiment, the step of performing jumbo-frame packaging processing to the second data packet, to obtain the target jumbo frame may, without limitation, be performed in the following mode:
adding the second data packet into a buffer;
packaging data in the buffer to be a jumbo frame, to obtain the target jumbo frame; and
releasing the buffer.

Optionally, in the present embodiment, the method may, without limitation, comprise performing reduction processing to the second data packet, storing into a sending buffer region, and subsequently packaging the data in the sending buffer to be a jumbo frame, to obtain the target jumbo frame.

Optionally, in the present embodiment, because the data in the sending buffer are packaged to be the jumbo frame, the method may, without limitation, comprise, while waiting for the sending of the target jumbo frame, releasing in advance the data in the buffer, and loading the second data packet of the next batch.

In an illustrative embodiment, after the step of transmitting the target jumbo frame to the second controlling node, the step of transmitting the data copy to the second controlling node may, without limitation, be performed in the following mode:
detecting whether packet loss happens in the target jumbo frame;
in response to packet loss happening in the target jumbo frame, by using a buffer-consistency protocol of the calculation quick-connection protocol, reading the data copy from the server main-memory; and
transmitting the data copy to the second controlling node.

Optionally, in the present embodiment, packet loss of the target jumbo frame may, without limitation, happen in multiple cases, for example, network congestion, erroneous configuration, and restriction by the network devices.

Optionally, in the present embodiment, because, before the jumbo-frame packaging processing to the second data packet, by using the storage protocol of the calculation quick-connection protocol, the second data packet is stored into the server main-memory of the distributed system, to obtain the data copy, if packet loss happens in the target jumbo frame, the method may comprise, by using the buffer protocol of the calculation quick-connection protocol, reading the data copy from the server main-memory, and transmitting the data copy to the second controlling node again.

Optionally, in the present embodiment, the step of transmitting the data copy to the second controlling node may, without limitation, be in multiple modes. For example, the data copy is packaged again to be a jumbo frame and transmitted. Alternatively, the data copy is packaged to be another frame format and transmitted.

In an illustrative embodiment, the step of transmitting the data copy to the second controlling node may, without limitation, be performed in the following mode:
splitting the data copy and packaging into a standard Ethernet frame; and
transmitting the standard Ethernet frame to the second controlling node.

Optionally, in the present embodiment, if packet loss happens in the target jumbo frame, the data copy is split and packaged into one or more standard Ethernet frames, and subsequently the standard Ethernet frames are transmitted to the second controlling node.

In an illustrative embodiment, after the step of transmitting the standard Ethernet frame to the second controlling node, the step of resuming the jumbo-frame packaging processing may, without limitation, be performed in the following mode:
in response to the standard Ethernet frame having been successfully transmitted, detecting a network state of the target controlling node; and
in response to the network state reaching a target network state, resuming the jumbo-frame packaging processing to subsequent data packets.

Optionally, in the present embodiment, if the standard Ethernet frame has been successfully transmitted, the network state of the target controlling node may, without limitation, be detected in multiple modes to determine whether to resume using the jumbo frame for the transmission, for example, determining the network state of the target controlling node according to the response time of the standard Ethernet frame, or acquiring other network parameters to determine the network state of the target controlling node.

Optionally, in the present embodiment, the network state may, without limitation, be determined according to the network parameters of the network, for example, comparing the network parameters with network thresholds, so as to determine the state of the network parameters, or acquiring the network parameters and calculating their weighted sum, so as to determine the network state. The network thresholds may, without limitation, be preset, or vary with the varying of the network parameters.

Optionally, in the present embodiment, the target network state may, without limitation, be used for indicating that the network state can perform the transmission by using the jumbo frame without packet loss. If the target network state is reached, the jumbo-frame packaging processing is resumed to the subsequent data packets.

In an illustrative embodiment, before the step of receiving the first data packet sent by the first controlling node, the obtaining the logical ring may, without limitation, be performed in the following mode:
according to a quantity of the nodes comprised by the distributed system, determining M and quantities of the nodes comprised by the node sets;
according to M and the quantities of the nodes comprised by the node sets, dividing the nodes comprised by the distributed system, to obtain the node sets of the quantity M; and
building links between the node sets of the quantity M, to obtain the logical ring.

Optionally, in the present embodiment, the method may, without limitation, comprises, according to the quantity of the nodes comprised by the distributed system, determining M and the quantities of the nodes comprised by the node sets. For example, taking the case as an example in which the distributed system comprises the nodes of the quantity P, the nodes of the quantity P may, without limitation, be divided into the node sets of the quantity M evenly, wherein each nodes of the quantity (M/P) are grouped into one node set. Alternatively, the nodes of the quantity P may also, without limitation, be divided into the node sets of the quantity M according to the practical demand. For example, the first nodes of the quantity A are grouped into one node set, the nodes of the quantity B among the remaining nodes are grouped into a second node set, the nodes of the quantity C among the remaining nodes are grouped into one node set, till finally the node sets of the quantity M are obtained. The above-described demand may include but is not limited to the demands on the data processing capacities of the nodes, the node training of the distributed system, and so on.

Optionally, in the present embodiment, the logical ring having the direction may, without limitation, be obtained in multiple modes. For example, the logical chains corresponding to the node sets are sequentially connected head-to-tail in a direction to obtain the logical ring having the direction, wherein the logical ring comprises all of the nodes of the node sets of the quantity M. Alternatively, the controlling nodes in the logical chains corresponding to the node sets are connected in a direction to obtain the logical ring having the direction, wherein the logical ring comprises the controlling nodes of the quantity M of the node sets of the quantity M.

Optionally, in the present embodiment, in a large-scale loop network structure, in the process of dividing the nodes comprised by the distributed system, it may, without limitation, be set that the interval between the controlling nodes does not exceed 4 nodes, to obtain the node sets of the quantity M. For example, taking the case as an example in which the distributed system comprises 12 nodes, each 4 nodes may, without limitation, be grouped into one node set to obtain 3 node sets; in other words, the neighboring controlling nodes are separated by 3 nodes therebetween. Alternatively, each 3 nodes are grouped into one node set to obtain 4 node sets; in other words, the neighboring controlling nodes are separated by 2 nodes therebetween.

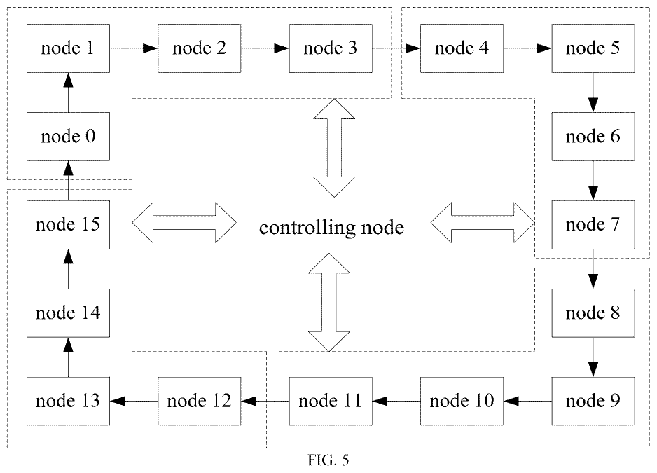

In an illustrative embodiment, an example of the process of the construction of the logical ring is provided. FIG. 5 is a schematic diagram of the process of the construction of the logical ring according to an embodiment of the present application. As shown in FIG. 5, taking the case as an example in which the distributed system comprises a node 0 to a node 15, according to the quantity 16 of the nodes comprised by the distributed system, the quantity M of the node sets is determined to be 4, and the quantity of the nodes comprised by each of the node sets is 4. The node 0 to a node 3 are grouped into a node set 1, and are sequentially connected to obtain a logical chain having a direction (the node 0 connected to a node 1 connected to a node 2 connected to the node 3). A node 4 to a node 7 are grouped into a node set 2, and are sequentially connected to obtain a logical chain having a direction (the node 4 connected to a node 5 connected to a node 6 connected to the node 7). A node 8 to a node 11 are grouped into a node set 3, and are sequentially connected to obtain a logical chain having a direction (the node 8 connected to a node 9 connected to a node 10 connected to the node 11). A node 12 to the node 15 are grouped into a node set 4, and are sequentially connected to obtain a logical chain having a direction (the node 12 connected to a node 13 connected to a node 14 connected to the node 15), to obtain 4 logical chains having a direction. Subsequently, the logical chains are connected head-to-tail to obtain the logical ring, wherein the tail of the logical chain 1 is connected to the head of the logical chain 2, the tail of the logical chain 2 is connected to the head of the logical chain 3, the tail of the logical chain 3 is connected to the head of the logical chain 4, and the tail of the logical chain 4 is connected to the head of the logical chain 1.

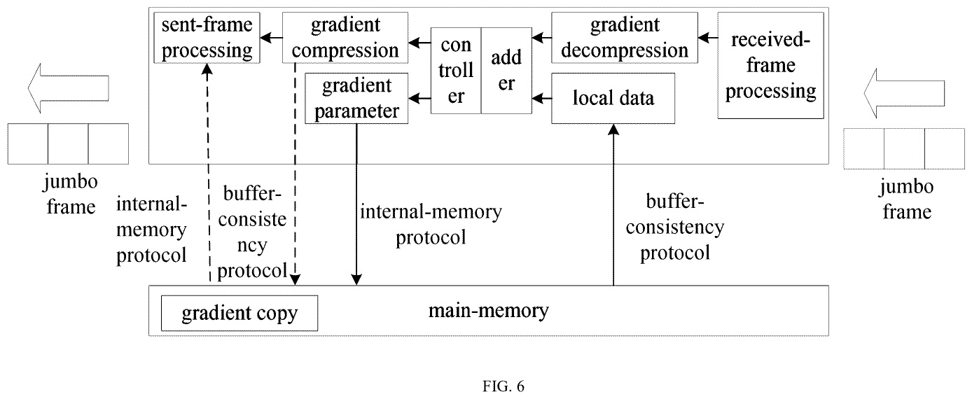

In an illustrative embodiment, an example of the process of the generation of the second data packet is provided. FIG. 6 is a schematic diagram of the process of the generation of the second data packet according to an embodiment of the present application. As shown in FIG. 6, taking the case as an example in which the first controlling node sends the first data packet by using a jumbo frame and the first data packet uses CP16 to record the data, the second data packet may, without limitation, be generated in the following mode:
when the first data packet has been received, allocating 2 times of the receiving internal-memory buffer region; by bit zeroizing, expanding from CP16 to CP32, and, by using CXL. cache (buffer-consistency protocol), reading the local CP32 data (the target data packet); performing addition calculation to the received first data packet and a local target data packet, and, by using a controller, determining whether the distributed computation has been completed; when it has been determined that the distributed computation has been completed, by using CXL. men (internal-memory protocol), storing the gradient data (the second data packet) into the server main-memory of the distributed system, to obtain the data copy, performing truncation compression from CP32 to CP16 to the gradient data, and subsequently performing jumbo-frame packaging processing to obtain a jumbo frame; sending the packaged jumbo frame to the second controlling node; and if packet loss happens at the jumbo frame, by using the CXL. cache protocol, acquiring a copy of the gradient data, splitting the data packet by using a protocol stack into standard Ethernet frames, packaging, and resending the data packet.

From the description on the above embodiments, a person skilled in the art can clearly know that the method according to the above embodiments may be implemented by means of software plus a necessary generic hardware platform, and, certainly, may also be implemented by hardware, but in many circumstances the former is the preferable embodiment. On the basis of such a comprehension, the substance of the technical solutions of the present application, or the part thereof that makes a contribution over the related art, may be embodied in the form of a software product. The computer software product is stored in a non-volatile readable storage medium (such as an ROM/RAM, a diskette and an optical disk), and contains multiple instructions configured so that a terminal device (which may be a mobile phone, a computer, a server, a network device and so on) implements the methods according to the embodiments of the present application.

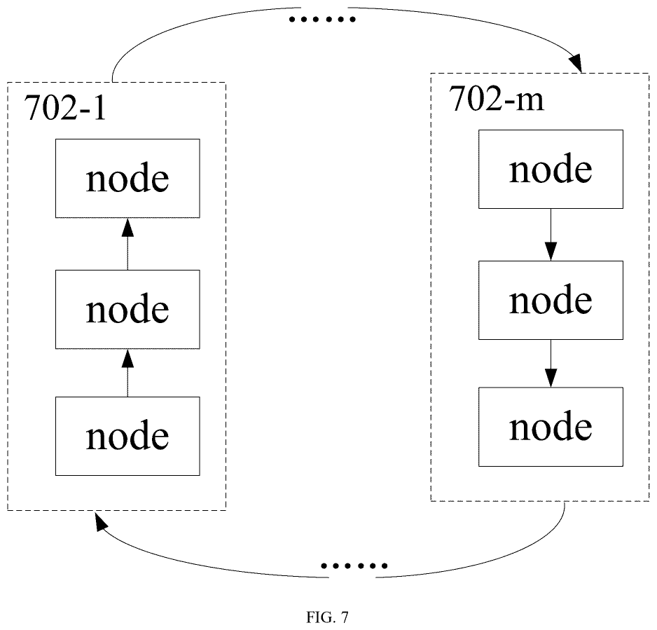

The present embodiment further provides a distributed system. FIG. 7 is a structural block diagram of a distributed system according to an embodiment of the present application. As shown in FIG. 7, nodes comprised by the distributed system are grouped into node sets of a quantity M, wherein M is greater than 1, a plurality of nodes that are comprised by each of the node sets are sequentially connected to obtain a logical chain having a direction (702-1 to 702-m), the logical chains of the quantity M (702-1 to 702-m) are sequentially connected to obtain a logical ring having a direction, and the last one node of each of the logical chains is a controlling node (704-1 to 704-m). Each of the controlling nodes serves as a target controlling node configured for implementing the steps of the method of node training for a distributed system according to any one of the above embodiments.

By using the distributed system, the target controlling node receives the first data packet sent by the preceding one controlling node connected to the target controlling node in the logical ring, i.e., the first controlling node, by using the first data packet and the training data of all of the nodes in the target node set where the target controlling node is located, executes the target training task to obtain the second data packet, and subsequently sends the second data packet to the second controlling node, whereby the second controlling node can use the training data of all of the nodes in the target node set where the target controlling node is located to perform the training. Because the target controlling node dispatches the target data packet that it receives to the other nodes than the target controlling node in the target node set, each of the nodes of the distributed system can obtain the training data of all of the nodes of the distributed system, which may solve the problem of a low efficiency of the node training of the distributed systems, to reach the effect of increasing the efficiency of the node training of the distributed system.

In an illustrative embodiment, the distributed system is further configured for:
receiving a first data packet sent by a first controlling node, wherein the first controlling node refers to a preceding one controlling node of the target controlling node in the logical ring;
by using the first data packet and a target data packet, executing a target training task of the target controlling node, to obtain a second data packet, wherein the target data packet carries training data of all of the nodes in a target node set where the target controlling node is located; and
sending the second data packet to a second controlling node, till the target controlling node has received training data of all of the controlling nodes of the distributed system, wherein the second controlling node refers to a next one controlling node of the target controlling node in the logical ring, and the training data of all of the controlling nodes of the distributed system and the target data packet are dispatched to the other nodes than the target controlling node in the target node set.

In an illustrative embodiment, before the step of, by using the first data packet and the target data packet, executing the target training task of the target controlling node, the distributed system is further configured for:
receiving a reference data packet sent by a preceding one node of the target controlling node in the target node set, wherein the reference data packet refers to a data packet that is formed by transmitting and operating training datum of each of the nodes in the target node set sequentially in a target logical chain of the target node set and is formed in the preceding one node; and
by using the reference data packet and a target training datum of the target controlling node, executing the target training task, to obtain the target data packet.

In an illustrative embodiment, before the step of receiving the first data packet sent by the first controlling node, the distributed system is further configured for:
detecting operation states of all of the nodes in the target node set; and
in response to a node the operation state of which is an abnormal operation state existing in the target node set, sending first indicating information to a third controlling node in the distributed system, wherein the first indicating information is for indicating that the target node set is in the abnormal operation state, and the third controlling node refers to a controlling node other than the target controlling node in the distributed system.

In an illustrative embodiment, in response to a node the operation state of which is an abnormal operation state existing in the target node set, the distributed system is further configured for:
disconnecting a link with the second controlling node.

In an illustrative embodiment, the distributed system is further configured for:
after the operation states of all of the nodes in the target node set have been detected, in response to all of the operation states of the nodes in the target node set being a normal operation state, receiving the first data packet sent by the first controlling node.

In an illustrative embodiment, the distributed system is further configured for:
detecting response times of all of the nodes in the target node set; and
determining a node in the target node set the response time of which is greater than or equal to a time threshold to be the node the operation state of which is the abnormal operation state.

In an illustrative embodiment, before the step of sending the second data packet to the second controlling node, the distributed system is further configured for:
receiving second indicating information sent by a fourth controlling node in the distributed system, wherein the second indicating information is for indicating that the node set where the fourth controlling node is located is in an abnormal operation state; and
in response to the fourth controlling node comprising the second controlling node, building a link with a first instance of the nodes of the logical chain that has a lowest distance to the target controlling node in the logical ring and is in a normal operation state, to obtain a logical ring that has been updated, wherein the logical chains of the quantity M are sequentially connected to obtain the logical ring having the direction.

In an illustrative embodiment, the distributed system is further configured for:
after the logical ring that has been updated has been obtained, sending the second data packet to a next one controlling node of the target controlling node in the logical ring that has been updated.

In an illustrative embodiment, in response to the fourth controlling node comprising the second controlling node, the step of building the link with the first instance of the nodes of the logical chain that has the lowest distance to the target controlling node in the logical ring and is in the normal operation state, the distributed system is further configured for:
searching for the second controlling node in the fourth controlling node;
in response to the second controlling node being found, searching for a next one controlling node of the second controlling node in the fourth controlling node; and in response to the next one controlling node of the second controlling node being not found, building a link with a first instance of the nodes of the logical chain where the next one controlling node of the second controlling node is located, to obtain the logical ring that has been updated.

In an illustrative embodiment, after the step of searching for the next one controlling node of the second controlling node in the fourth controlling node, the distributed system is further configured for:
in response to the next one controlling node of the second controlling node being found, continuing to search for the controlling nodes along the logical ring downstream, till a candidate controlling node in the normal operation state is found; and
in response to the candidate controlling node being not the target controlling node, building a link with a first instance of the nodes of the logical chain where the candidate controlling node is located, to obtain the logical ring that has been updated.

In an illustrative embodiment, after the step of continuing to search for the controlling nodes along the logical ring downstream, till the candidate controlling node in the normal operation state is found, the distributed system is further configured for:
in response to the candidate controlling node being the target controlling node, reporting alarming information, wherein the alarming information is for indicating that the logical ring where the target controlling node is located malfunctions.

In an illustrative embodiment, in response to the fourth controlling node comprising the second controlling node, the distributed system is further configured for:
disconnecting a link with the second controlling node.

In an illustrative embodiment, the distributed system is further configured for:
by using an internal-memory protocol of a calculation quick-connection protocol, storing the second data packet into a server main-memory of the distributed system, to obtain a data copy;
performing jumbo-frame packaging processing to the second data packet, to obtain a target jumbo frame; and
transmitting the target jumbo frame to the second controlling node.

In an illustrative embodiment, the distributed system is further configured for:
adding the second data packet into a buffer;
packaging data in the buffer to be a jumbo frame, to obtain the target jumbo frame; and releasing the buffer.

In an illustrative embodiment, after the step of transmitting the target jumbo frame to the second controlling node, the distributed system is further configured for:
detecting whether packet loss happens in the target jumbo frame;
in response to packet loss happening in the target jumbo frame, by using a buffer-consistency protocol of the calculation quick-connection protocol, reading the data copy from the server main-memory; and
transmitting the data copy to the second controlling node.

In an illustrative embodiment, the distributed system is further configured for:
splitting the data copy and packaging into a standard Ethernet frame; and
transmitting the standard Ethernet frame to the second controlling node.

In an illustrative embodiment, after the step of transmitting the standard Ethernet frame to the second controlling node, the distributed system is further configured for:
in response to the standard Ethernet frame having been successfully transmitted, detecting a network state of the target controlling node; and
in response to the network state reaching a target network state, resuming the jumbo-frame packaging processing to subsequent data packets.

In an illustrative embodiment, before the step of receiving the first data packet sent by the first controlling node, the distributed system is further configured for:
according to a quantity of the nodes comprised by the distributed system, determining M and quantities of the nodes comprised by the node sets;
according to M and the quantities of the nodes comprised by the node sets, dividing the nodes comprised by the distributed system, to obtain the node sets of the quantity M; and
building links between the node sets of the quantity M, to obtain the logical ring.

The present embodiment further provides an apparatus of node training for a distributed system, wherein the apparatus is configured for implementing the above embodiments and alternative embodiments, wherein what have been described are not discussed further. As used below, the term “module” may implement the combination of software and/or hardware of predetermined functions. Although the apparatus described in the following embodiments is implemented preferably with software, implementation of hardware, or a combination of software and hardware, is also feasible and envisaged.

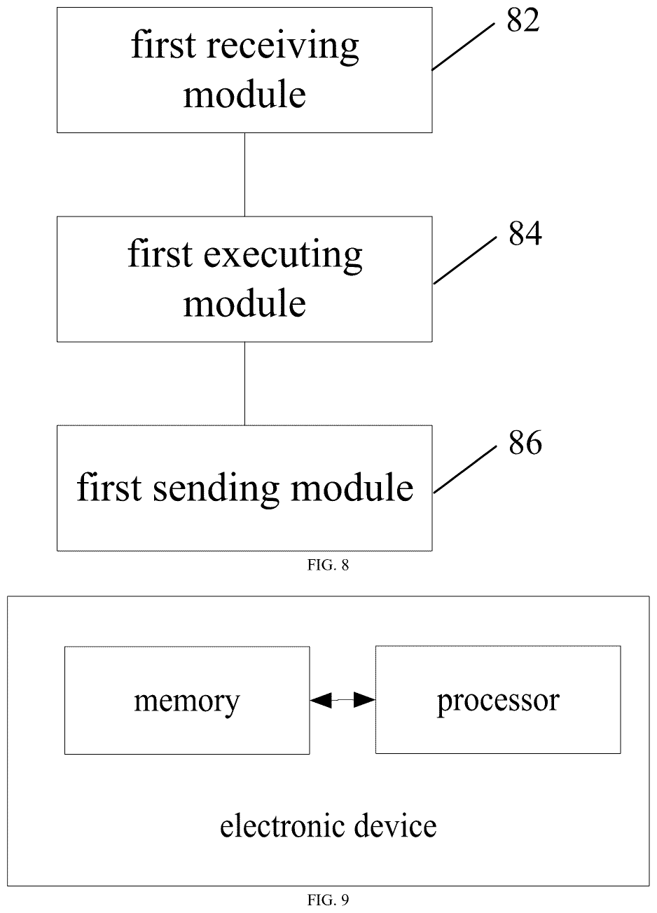

FIG. 8 is a structural block diagram of an apparatus of node training for a distributed system according to an embodiment of the present application. As shown in FIG. 8, the apparatus is applied in a target controlling node deployed in the distributed system, nodes comprised by the distributed system are grouped into node sets of a quantity M, wherein M is greater than 1, a plurality of nodes that are comprised by each of the node sets are sequentially connected to obtain a logical chain having a direction, the node sets of the quantity M are sequentially connected to obtain a logical ring having a direction, the last one node of each of the logical chains is a controlling node, the target controlling node refers to each of the controlling nodes, and the apparatus comprises:
a first receiving module 82 configured for receiving a first data packet sent by a first controlling node, wherein the first controlling node refers to a preceding one controlling node of the target controlling node in the logical ring;
a first executing module 84 configured for, by using the first data packet and a target data packet, executing a target training task of the target controlling node, to obtain a second data packet, wherein the target data packet carries training data of all of the nodes in a target node set where the target controlling node is located; and
a first sending module 86 configured for sending the second data packet to a second controlling node, till the target controlling node has received training data of all of the controlling nodes of the distributed system, wherein the second controlling node refers to a next one controlling node of the target controlling node in the logical ring, and the training data of all of the controlling nodes of the distributed system and the target data packet are dispatched to the other nodes than the target controlling node in the target node set.

By using the apparatus, the target controlling node receives the first data packet sent by the preceding one controlling node connected to the target controlling node in the logical ring, i.e., the first controlling node, by using the first data packet and the training data of all of the nodes in the target node set where the target controlling node is located, executes the target training task to obtain the second data packet, and subsequently sends the second data packet to the second controlling node, whereby the second controlling node can use the training data of all of the nodes in the target node set where the target controlling node is located to perform the training. Because the target controlling node dispatches the target data packet that it receives to the other nodes than the target controlling node in the target node set, each of the nodes of the distributed system can obtain the training data of all of the nodes of the distributed system, which may solve the problem of a low efficiency of the node training of the distributed systems, to reach the effect of increasing the efficiency of the node training of the distributed system.

In an illustrative embodiment, the apparatus further comprises:
a second receiving module configured for receiving a reference data packet sent by a preceding one node of the target controlling node in the target node set, wherein the reference data packet refers to a data packet that is formed by transmitting and operating training datum of each of the nodes in the target node set sequentially in a target logical chain of the target node set and is formed in the preceding one node; and
a second executing module configured for, by using the reference data packet and a target training datum of the target controlling node, executing the target training task, to obtain the target data packet.

In an illustrative embodiment, the apparatus further comprises:
a first detecting module configured for detecting operation states of all of the nodes in the target node set; and
a second sending module configured for, in response to a node the operation state of which is an abnormal operation state existing in the target node set, sending first indicating information to a third controlling node in the distributed system, wherein the first indicating information is for indicating that the target node set is in the abnormal operation state, and the third controlling node refers to a controlling node other than the target controlling node in the distributed system.

In an illustrative embodiment, the apparatus further comprises:
a first link disconnecting module configured for disconnecting a link with the second controlling node.

In an illustrative embodiment, the first receiving module comprises:
a receiving unit configured for, after the operation states of all of the nodes in the target node set have been detected, in response to all of the operation states of the nodes in the target node set being a normal operation state, receiving the first data packet sent by the first controlling node.

In an illustrative embodiment, the first detecting module comprises:
a detecting unit configured for detecting response times of all of the nodes in the target node set; and
a processing unit configured for determining a node in the target node set the response time of which is greater than or equal to a time threshold to be the node the operation state of which is the abnormal operation state.

In an illustrative embodiment, the apparatus further comprises:
a third receiving module configured for receiving second indicating information sent by a fourth controlling node in the distributed system, wherein the second indicating information is for indicating that the node set where the fourth controlling node is located is in an abnormal operation state; and
a first link building module configured for, in response to the fourth controlling node comprising the second controlling node, building a link with a first instance of the nodes of the logical chain that has a lowest distance to the target controlling node in the logical ring and is in a normal operation state, to obtain a logical ring that has been updated, wherein the logical chains of the quantity M are sequentially connected to obtain the logical ring having the direction.

In an illustrative embodiment, the first sending module comprises:
a sending unit configured for, after the logical ring that has been updated has been obtained, sending the second data packet to a next one controlling node of the target controlling node in the logical ring that has been updated.

In an illustrative embodiment, the first link building module comprises:
a first searching unit configured for searching for the second controlling node in the fourth controlling node;
a second unit configured for, in response to the second controlling node being found, searching for a next one controlling node of the second controlling node in the fourth controlling node; and
a link building unit configured for, in response to the next one controlling node of the second controlling node being not found, building a link with a first instance of the nodes of the logical chain where the next one controlling node of the second controlling node is located, to obtain the logical ring that has been updated.

In an illustrative embodiment, the apparatus further comprises:
a searching module configured for, in response to the next one controlling node of the second controlling node being found, continuing to search for the controlling nodes along the logical ring downstream, till a candidate controlling node in the normal operation state is found; and
a second link building module configured for, in response to the candidate controlling node being not the target controlling node, building a link with a first instance of the nodes of the logical chain where the candidate controlling node is located, to obtain the logical ring that has been updated.

In an illustrative embodiment, the apparatus further comprises:
a reporting module configured for, in response to the candidate controlling node being the target controlling node, reporting alarming information, wherein the alarming information is for indicating that the logical ring where the target controlling node is located malfunctions.

In an illustrative embodiment, the apparatus further comprises:
a second link disconnecting module configured for disconnecting a link with the second controlling node.

In an illustrative embodiment, the first sending module comprises:
a storing unit configured for, by using an internal-memory protocol of a calculation quick-connection protocol, storing the second data packet into a server main-memory of the distributed system, to obtain a data copy;
a jumbo-frame-packaging-processing unit configured for performing jumbo-frame packaging processing to the second data packet, to obtain a target jumbo frame; and
a first transmitting unit configured for transmitting the target jumbo frame to the second controlling node.

In an illustrative embodiment, the jumbo-frame-packaging-processing unit is further configured for:
adding the second data packet into a buffer;
packaging data in the buffer to be a jumbo frame, to obtain the target jumbo frame; and
releasing the buffer.

In an illustrative embodiment, the apparatus further comprises:
a second detecting module configured for detecting whether packet loss happens in the target jumbo frame;
a reading module configured for, in response to packet loss happening in the target jumbo frame, by using a buffer-consistency protocol of the calculation quick-connection protocol, reading the data copy from the server main-memory; and
a transmitting module configured for transmitting the data copy to the second controlling node.

In an illustrative embodiment, the transmitting module comprises:
a splitting and packaging unit configured for splitting the data copy and packaging into a standard Ethernet frame; and
a second transmitting unit configured for transmitting the standard Ethernet frame to the second controlling node.

In an illustrative embodiment, the apparatus further comprises:
a third detecting module configured for, in response to the standard Ethernet frame having been successfully transmitted, detecting a network state of the target controlling node; and
a resuming module configured for, in response to the network state reaching a target network state, resuming the jumbo-frame packaging processing to subsequent data packets.

In an illustrative embodiment, the apparatus further comprises:
a processing module configured for, according to a quantity of the nodes comprised by the distributed system, determining M and quantities of the nodes comprised by the node sets;
a dividing module configured for, according to M and the quantities of the nodes comprised by the node sets, dividing the nodes comprised by the distributed system, to obtain the node sets of the quantity M; and
a third link building module configured for building links between the node sets of the quantity M, to obtain the logical ring.

It should be noted that the above modules may be implemented by software or hardware. The latter may be implemented in the following modes but is not limited thereto: all of the above modules are located in the same one processor, or the above modules are located in different processors in any combinations.

An embodiment of the present application further provides a non-volatile readable storage medium, wherein the non-volatile readable storage medium stores a computer program, and the computer program is configured for, when being executed, implementing the steps according to any one of the process embodiments stated above.

In an illustrative embodiment, the non-volatile readable storage medium may include but is not limited to various media that can store a computer program, such as a USB flash disk, a Read-Only Memory (referred to for short as ROM), a Random Access Memory (referred to for short as RAM), a mobile hard disk drive, a diskette and an optical disk.

An embodiment of the present application further provides an electronic device. FIG. 9 is a structural block diagram of an electronic device according to an embodiment of the present application. As shown in FIG. 9, the electronic device comprises a memory and a processor, the memory stores a computer program, and the processor is configured for executing the computer program to implement the steps according to any one of the process embodiments stated above.

In an illustrative embodiment, the electronic device may further comprise a transmitting device and an inputting-outputting device, wherein the transmitting device is connected to the processor, and the inputting-outputting device is connected to the processor.

The alternative examples in the present embodiment may refer to the examples described in the above embodiments and illustrative embodiments, and are not discussed further in the present embodiment.

Apparently, a person skilled in the art should understand that the modules or steps described above according to the present application may be embodied by using generic computing devices. They may be concentrated in a single computing device, or distributed in a network formed by a plurality of computing devices. They may be embodied by using a program code executable by a computing device, whereby they may be stored in a storing device and executed by the computing device. Furthermore, in some cases, the illustrated or described steps may be executed in sequences different from the sequences used herein, or they may be separately fabricated into integrated-circuit modules, or a plurality of modules or steps among them may be fabricated into a single integrated-circuit module to be embodied. Accordingly, the present application is not limited to any particular combination of hardware and software.

The above are merely alternative embodiments of the present application, and are not indented to limit the present application. For a person skilled in the art, the present application may have various modifications and variations. Any modifications, equivalent substitutions and improvements that are made within the principle of the present application should fall within the protection scope of the present application.

1. A method of node training for a distributed system, wherein
the method is applied in a target controlling node deployed in the distributed system, nodes comprised by the distributed system are grouped into node sets of a quantity M, wherein M is greater than 1, a plurality of nodes that are comprised by each of the node sets are sequentially connected to obtain a logical chain having a direction, the node sets of the quantity M are sequentially connected to obtain a logical ring having a direction, a last one node of each of the logical chains is a controlling node, the target controlling node refers to each of the controlling nodes, and the method comprises:
receiving a first data packet sent by a first controlling node, wherein the first controlling node refers to a preceding one controlling node of the target controlling node in the logical ring;
by using the first data packet and a target data packet, executing a target training task of the target controlling node, to obtain a second data packet, wherein the target data packet carries training data of all of the nodes in a target node set where the target controlling node is located; and
sending the second data packet to a second controlling node, till the target controlling node has received training data of all of the controlling nodes of the distributed system, wherein the second controlling node refers to a next one controlling node of the target controlling node in the logical ring, and the training data of all of the controlling nodes of the distributed system and the target data packet are dispatched to the other nodes than the target controlling node in the target node set.

2. The method according to claim 1, wherein
before the step of, by using the first data packet and the target data packet, executing the target training task of the target controlling node, the method further comprises:
receiving a reference data packet sent by a preceding one node of the target controlling node in the target node set, wherein the reference data packet refers to a data packet that is formed by transmitting and operating training datum of each of the nodes in the target node set sequentially in a target logical chain of the target node set and is formed in the preceding one node; and
by using the reference data packet and a target training datum of the target controlling node, executing the target training task, to obtain the target data packet.

3. The method according to claim 1, wherein
before the step of receiving the first data packet sent by the first controlling node, the method further comprises:
detecting operation states of all of the nodes in the target node set; and
in response to a node the operation state of which is an abnormal operation state existing in the target node set, sending first indicating information to a third controlling node in the distributed system, wherein the first indicating information is for indicating that the target node set is in the abnormal operation state, and the third controlling node refers to a controlling node other than the target controlling node in the distributed system.

4. The method according to claim 3, wherein
in response to a node the operation state of which is an abnormal operation state existing in the target node set, the method further comprises:
disconnecting a link with the second controlling node.

5. The method according to claim 3, wherein
the step of receiving the first data packet sent by the first controlling node comprises:
after the operation states of all of the nodes in the target node set have been detected, in response to all of the operation states of the nodes in the target node set being a normal operation state, receiving the first data packet sent by the first controlling node.

6. The method according to claim 3, wherein
the step of detecting the operation states of all of the nodes in the target node set comprises:
detecting response times of all of the nodes in the target node set; and
determining a node in the target node set the response time of which is greater than or equal to a time threshold to be the node the operation state of which is the abnormal operation state.

7. The method according to claim 1, wherein
before the step of sending the second data packet to the second controlling node, the method further comprises:
receiving second indicating information sent by a fourth controlling node in the distributed system, wherein the second indicating information is for indicating that the node set where the fourth controlling node is located is in an abnormal operation state; and
in response to the fourth controlling node comprising the second controlling node, building a link with a first instance of the nodes of the logical chain that has a lowest distance to the target controlling node in the logical ring and is in a normal operation state, to obtain a logical ring that has been updated, wherein the logical chains of the quantity M are sequentially connected to obtain the logical ring having the direction.

8. The method according to claim 7, wherein
the step of sending the second data packet to the second controlling node comprises:
after the logical ring that has been updated has been obtained, sending the second data packet to a next one controlling node of the target controlling node in the logical ring that has been updated.

9. The method according to claim 7, wherein
in response to the fourth controlling node comprising the second controlling node, the step of building the link with the first instance of the nodes of the logical chain that has the lowest distance to the target controlling node in the logical ring and is in the normal operation state comprises:
searching for the second controlling node in the fourth controlling node;
in response to the second controlling node being found, searching for a next one controlling node of the second controlling node in the fourth controlling node; and
in response to the next one controlling node of the second controlling node being not found, building a link with a first instance of the nodes of the logical chain where the next one controlling node of the second controlling node is located, to obtain the logical ring that has been updated.

10. The method according to claim 9, wherein
after the step of searching for the next one controlling node of the second controlling node in the fourth controlling node, the method further comprises:
in response to the next one controlling node of the second controlling node being found, continuing to search for the controlling nodes along the logical ring downstream, till a candidate controlling node in the normal operation state is found; and
in response to the candidate controlling node being not the target controlling node, building a link with a first instance of the nodes of the logical chain where the candidate controlling node is located, to obtain the logical ring that has been updated.

11. The method according to claim 10, wherein
after the step of continuing to search for the controlling nodes along the logical ring downstream, till the candidate controlling node in the normal operation state is found, the method further comprises:
in response to the candidate controlling node being the target controlling node, reporting alarming information, wherein the alarming information is for indicating that the logical ring where the target controlling node is located malfunctions.

12. The method according to claim 7, wherein
in response to the fourth controlling node comprising the second controlling node, the method further comprises:
disconnecting a link with the second controlling node.

13. The method according to claim 1, wherein
the step of sending the second data packet to the second controlling node comprises:
by using an internal-memory protocol of a calculation quick-connection protocol, storing the second data packet into a server main-memory of the distributed system, to obtain a data copy;
performing jumbo-frame packaging processing to the second data packet, to obtain a target jumbo frame; and
transmitting the target jumbo frame to the second controlling node.

14. The method according to claim 13, wherein
the step of performing jumbo-frame packaging processing to the second data packet, to obtain the target jumbo frame comprises:
adding the second data packet into a buffer;
packaging data in the buffer to be a jumbo frame, to obtain the target jumbo frame; and
releasing the buffer.

15. The method according to claim 13, wherein
after the step of transmitting the target jumbo frame to the second controlling node, the method further comprises:
detecting whether packet loss happens in the target jumbo frame;
in response to packet loss happening in the target jumbo frame, by using a buffer-consistency protocol of the calculation quick-connection protocol, reading the data copy from the server main-memory; and
transmitting the data copy to the second controlling node.

16. The method according to claim 15, wherein
the step of transmitting the data copy to the second controlling node comprises:
splitting the data copy and packaging into a standard Ethernet frame; and
transmitting the standard Ethernet frame to the second controlling node.

17. (canceled)

18. The method according to claim 1, wherein
before the step of receiving the first data packet sent by the first controlling node, the method further comprises:
according to a quantity of the nodes comprised by the distributed system, determining M and quantities of the nodes comprised by the node sets;
according to M and the quantities of the nodes comprised by the node sets, dividing the nodes comprised by the distributed system, to obtain the node sets of the quantity M; and
building links between the node sets of the quantity M, to obtain the logical ring.

19. A distributed system, wherein
nodes comprised by the distributed system are grouped into node sets of a quantity M, wherein M is greater than 1, a plurality of nodes that are comprised by each of the node sets are sequentially connected to obtain a logical chain having a direction, the logical chains of the quantity M are sequentially connected to obtain a logical ring having a direction, and a last one node of each of the logical chains is a controlling node; and
each of the controlling nodes serves as a target controlling node configured for implementing the steps of the method according to claim 1.

20. (canceled)

21. A non-volatile readable storage medium, wherein
the non-volatile readable storage medium stores a computer program, and the computer program, when executed by a processor, implements the steps of the method according to claim 1.

22. An electronic device, comprising a memory, a processor, and a computer program that is stored in the memory and executable in the processor, wherein
the processor, when executing the computer program, implements the steps of the method according to claim 1.
